(19) United States
(12) Patent Application Publication
(10) Pub. No.: US 2026/0249807 A1
(43) Pub. Date: Aug. 27, 2026

(54) SEATBELT RETENTION AND ENFORCEMENT DEVICE AND METHOD OF USE

(71) Applicant: Robert Dahlberg Bolser, Manchester, NH (US)

(72) Inventor: Robert Dahlberg Bolser, Manchester, NH (US)

(21) Appl. No.: 19/547,580

(22) Filed: Feb. 23, 2026

Related U.S. Application Data
(60) Provisional application No. 63/761,589, filed on Feb. 21, 2025.

(51) Int. Cl. B60R 22/18

(52) U.S. Cl. CPC B60R 22/18

(57) ABSTRACT

A seatbelt enforcer may include a body with a slot configured to receive seatbelt webbing and a hook configured to engage a steering wheel rim. When the hook engages the steering wheel, the seatbelt enforcer may maintain the seatbelt webbing at a desired length for an operator to fasten the seatbelt and may maintain a seatbelt clip in a desired position along the seatbelt webbing by holding the webbing at an angle that prevents gravity from pulling the clip down the webbing. The seatbelt enforcer may create a physical obstruction that prevents the steering wheel from being used, thereby preventing the vehicle from being driven until the operator has fastened the seatbelt. By unhooking the seatbelt enforcer and quickly latching the seatbelt, the operator may simultaneously remove the obstruction, making the vehicle drivable.

### RELATED APPLICATIONS

This application claims the benefit of U.S. Provisional Application Ser. No. 63/761,589, filed Feb. 21, 2025, entitled Belt-Safe, the entire disclosure of which is herein incorporated by reference.

### FIELD OF THE INVENTION

The disclosure relates to seatbelt retention devices for vehicles requiring high-frequency entry and exit cycles, and more particularly to devices that prevent seatbelt retraction and clip migration while encouraging seatbelt compliance in commercial vehicle operations.

### BACKGROUND OF THE INVENTION

In some commercial vehicle configurations, the driver may be required to exit through the passenger-side door or through a center position toward the rear of the vehicle. Such configurations may be found in delivery trucks with curbside delivery requirements, yard switchers, certain crane cabs, and airport tuggers where operational efficiency requires right-side or rear egress. The driver is required to unfasten the seatbelt before each exit, creating a high-frequency unbuckling and rebuckling cycle that may not be present in conventional passenger vehicles.

Conventional three-point seatbelt systems may include a spring-loaded retractor mechanism that automatically retracts belt webbing when the belt is unfastened. In passenger vehicles with infrequent entry and exit cycles, this retraction behavior may be acceptable. However, in commercial vehicles requiring frequent entry and exit, such as delivery trucks, yard switchers, crane cabs, and airport tuggers, the retractor mechanism may pull the belt webbing back into the B-pillar housing dozens or hundreds of times per day. Upon retraction, the seatbelt clip may slide down the belt webbing toward the retractor due to gravity and loss of tension. This migration may require the operator to repeatedly retrieve the belt from behind or above the shoulder, pull sufficient webbing from the retractor to create slack, locate the clip, and reposition the clip along the webbing before re-fastening the belt with each entry cycle.

The combination of right-side or rear exit requirements with high-frequency entry and exit cycles may create a compounding problem. Each exit may require unfastening the seatbelt, and each re-entry may require retrieving and repositioning both the retracted belt and the migrated clip. This repetitive cycle may occur dozens or hundreds of times per day in commercial vehicle operations.

In some commercial vehicle operations, drivers may perform hundreds of entry and exit cycles per day. The repetitive reaching, pulling, and adjusting required to retrieve and reposition a retracted seatbelt and migrated clip may create ergonomic strain and may increase the time required for each entry cycle. In some cases, operators under time pressure may reduce or omit seatbelt use, creating safety concerns and regulatory compliance issues under Department of Transportation requirements.

In some cases, drivers may choose to drive short distances between stops without fastening the seatbelt due to the inconvenience of repeated buckling and unbuckling. This behavior may occur even when the driver intends to comply with safety requirements, particularly when stops are closely spaced and time pressure is high. Additionally, even when a driver intends to fasten the seatbelt upon re-entry, a retracted belt and migrated clip may not provide a In some embodiments, when the seatbelt enforcer is engaged with the steering wheel, the seatbelt webbing may be maintained at an exact length necessary for an operator to fasten the seatbelt and the seatbelt clip may be maintained in a desired location. By holding the seatbelt webbing at an angle clipped to the steering wheel, gravity may be prevented from pulling the clip out of place. The operator may not need to make any adjustments to the webbing length or clip position, and the seatbelt may be quickly and easily fastened. When the seatbelt enforcer is engaged with the steering wheel, the seatbelt webbing may create a physical obstruction that prevents the steering wheel from being used, thereby preventing the vehicle from being driven until the operator has fastened the seatbelt. By unhooking the seatbelt enforcer and quickly latching the seatbelt that has the desired length of webbing and correctly positioned clip, the operator may simultaneously remove the obstruction, making the vehicle drivable. The seatbelt enforcer may be configured for high-frequency engagement and disengagement cycles. or physical reminder to do so. The driver may begin driving before realizing the belt has not been fastened, or may postpone fastening until after the vehicle is in motion.

Some prior art devices may provide belt retaining systems that hold a belt in an open position while the belt remains buckled, or that alter belt path geometry for different occupant sizes, however, these devices are not appropriate for delivery vehicles or others with passenger side exit, or exit from the middle and out the back of the vehicle. For example, some devices may include hook means for engaging a steering wheel while the belt remains latched, requiring the operator to hook and unhook the device with each entry and exit cycle, and requiring the driver to exit from the driver's side door. Other devices may include slots for rerouting belt webbing to change the belt path. However, such devices may not address the specific problem of belt retraction and clip migration that occurs when a belt is repeatedly unfastened during high-frequency entry and exit cycles. Additionally, multi-purpose devices with multiple functions may introduce structural complexity that may not be necessary for simple retraction prevention.

Other approaches may rely on operator training, management oversight, or disciplinary measures to encourage seatbelt compliance. However, such approaches may not address the underlying physical inconvenience and ergonomic burden that may contribute to non-compliance in high-frequency commercial vehicle operations. Therefore, there may be a need for a device that prevents seatbelt retraction and clip migration during high-frequency entry and exit cycles while encouraging seatbelt compliance in commercial vehicle operations.

### SUMMARY OF THE INVENTION

In some embodiments, a seatbelt enforcer may be provided to address the problem of belt retraction and clip migration in vehicles requiring high-frequency entry and exit cycles. The seatbelt enforcer may include a body with a slot configured to receive seatbelt webbing and a hook configured to engage a steering wheel rim. When engaged with the steering wheel, the seatbelt enforcer may prevent the seatbelt from retracting into the B-pillar housing and may maintain the seatbelt clip in a predetermined position, eliminating the need for the operator to repeatedly retrieve and reposition the belt and clip with each entry cycle.

In some embodiments, when the seatbelt enforcer is engaged with the steering wheel, the seatbelt webbing may be maintained at an exact length necessary for the operator to fasten the seatbelt and the seatbelt clip may be maintained in a desired location on the webbing. By holding the seatbelt webbing at an angle clipped to the steering wheel, gravity may be prevented from pulling the clip out of place. The operator may not need to make any adjustments to the webbing length or clip position, and the seatbelt may be quickly and easily fastened after unhooking from the steering wheel. Additionally, when the seatbelt enforcer is engaged with the steering wheel, the seatbelt webbing may create a physical obstruction that prevents the steering wheel from being used, thereby preventing the vehicle from being driven until the operator has fastened the seatbelt. By unhooking the seatbelt enforcer and quickly latching the seatbelt that has the desired length of webbing and correctly positioned clip, the operator may simultaneously remove the obstruction, making the vehicle drivable while also increasing driver safety and compliance. The seatbelt enforcer may be configured for rapid engagement and disengagement to accommodate high-frequency commercial vehicle operations.

In an embodiment, a seatbelt enforcer for use with a vehicle seatbelt system may include a body having a slot configured to receive a seatbelt webbing and a hook extending from the body and configured to engage a steering wheel rim. When the hook engages the steering wheel rim and the seatbelt webbing is received in the slot, the seatbelt enforcer may be configured to prevent retraction of the seatbelt webbing and to maintain a seatbelt clip in a desired position along the seatbelt webbing while the seatbelt is unfastened.

The hook may be positioned forward of a front sidewall of a base of the body such that the hook remains out of the way when a user holds the base. The slot may include a retaining arm configured to retain the seatbelt webbing within the slot. The retaining arm may be flexible and configured to deflect to allow insertion and removal of the seatbelt webbing. The retaining arm and the body may define a serpentine path that closes a passage and prevents the seatbelt webbing from accidentally disengaging from the slot. The hook may include a nub configured to increase contact area with the steering wheel rim. The seatbelt enforcer may be configured to break away under a predetermined force threshold. The retaining arm may include an overhang and the body may include a top of base, the overhang and the top of base defining an overhang nook configured to constrain the seatbelt webbing. When the hook engages the steering wheel rim, the seatbelt webbing may be held at an angle that prevents gravity from pulling the seatbelt clip down the seatbelt webbing. When the hook engages the steering wheel rim, the seatbelt enforcer and seatbelt webbing may create a physical obstruction that prevents the steering wheel from being used.

In an embodiment, a vehicle occupant restraint system may include a vehicle seatbelt assembly including a seatbelt webbing, a seatbelt clip, and a retractor, and a seatbelt enforcer including a body including a slot configured to receive the seatbelt webbing and a hook extending from the body and configured to engage a steering wheel rim. When the hook engages the steering wheel rim and the seatbelt webbing is received in the slot, the seatbelt enforcer may be configured to prevent the retractor from retracting the seatbelt webbing and to maintain the seatbelt clip in a desired position along the seatbelt webbing.

When the hook engages the steering wheel rim, the seatbelt webbing may be held at an angle that prevents gravity from pulling the seatbelt clip down the seatbelt webbing. The seatbelt webbing may create a physical obstruction that prevents the steering wheel from being used, thereby preventing the vehicle from being driven until an operator has fastened the seatbelt.

In an embodiment, a method for retaining a seatbelt in a vehicle may include engaging a seatbelt webbing with a slot of a seatbelt enforcer, engaging a hook of the seatbelt enforcer with a steering wheel rim, maintaining the seatbelt webbing in an extended position at a desired length for an operator to fasten the seatbelt while the hook engages the steering wheel rim, and maintaining a seatbelt clip in a desired position along the seatbelt webbing while the hook engages the steering wheel rim by holding the seatbelt webbing at an angle that prevents gravity from pulling the seatbelt clip down the seatbelt webbing.

The method may further include creating a physical obstruction with the seatbelt webbing that prevents the steering wheel from being used, thereby preventing the vehicle from being driven until the operator has fastened the seatbelt. The method may further include disengaging the hook from the steering wheel rim and fastening the seatbelt clip before operating the vehicle. Disengaging the hook and fastening the seatbelt clip may simultaneously remove the physical obstruction from the steering wheel, making the vehicle drivable. The operator may exit the vehicle through a passenger-side door or through a center position toward a rear of the vehicle while the hook engages the steering wheel rim. The seatbelt webbing maintained at the desired length and the seatbelt clip maintained in the desired position along the seatbelt webbing may allow the operator to fasten the seatbelt without making any adjustments to webbing length or clip position.

### BRIEF DESCRIPTION OF THE DRAWINGS

The invention description below refers to the accompanying drawings, of which:

FIG. 1 is a perspective view of a seatbelt enforcer, according to an illustrative embodiment.

FIG. 2 is an enlarged view of the slot and rounded contact surface of the retaining arm, according to an illustrative embodiment.

FIG. 3 is a perspective view of the seatbelt enforcer with a user opening the retaining arm, according to an illustrative embodiment.

FIG. 4 is a perspective view of a seatbelt partially placed within the slot of the seatbelt enforcer, according to an illustrative embodiment.

FIG. 5 is a perspective view of a seatbelt enforcer in place on a fastened seatbelt, according to an illustrative embodiment.

FIG. 6 is a perspective view of a user who has unfastened his seatbelt and is preparing to hook the seatbelt enforcer to the steering wheel, according to an illustrative embodiment.

FIG. 7 is a perspective view of the seatbelt enforcer hooked to the steering wheel, thereby preventing the seatbelt from retracting and preventing the vehicle from being driven, according to an illustrative embodiment.

FIG. 8 is an enlarged view of the seatbelt enforcer hooked to the steering wheel, according to an illustrative embodiment.

FIG. 9 is a perspective view of a seatbelt enforcer holding the seatbelt and preventing belt retraction while the driver has exited from the right side of the vehicle, according to an illustrative embodiment.

FIG. 10 is a perspective view showing the driver having returned to his seat, and preparing to unhook the seatbelt enforcer from the steering wheel, according to an illustrative embodiment.

FIG. 11 is a perspective view of a driver preparing to fasten the seatbelt, according to an illustrative embodiment.

FIG. 12 is a perspective view of the seatbelt fastened around the driver, and the seatbelt enforcer resting on the belt above the clip, according to an illustrative embodiment.

### DETAILED DESCRIPTION

The present invention relates to a seatbelt enforcer system and method of use. There are a great many possible implementations of the invention, too many to describe herein. Various possible implementations are described below. It cannot be emphasized too strongly, however, that these are descriptions of implementations of the invention, and not descriptions of the invention, which is not limited to the detailed implementations described in this section but is described in broader terms in the claims. Although this invention is disclosed in the context of certain preferred embodiments and examples, it should be understood by those skilled in the art that the present invention extends beyond the specifically disclosed embodiments and/or uses of the invention and obvious modifications and equivalents thereof. Further, the terms and phrases used herein are not intended to be limiting but rather to provide an understandable description of the invention.

Various embodiments are discussed hereinafter. It should be noted that the figures are described only to facilitate the description of the embodiments. They are not intended as an exhaustive description of the invention and do not limit the scope of the invention. Additionally, any particular embodiment need not have all the aspects or advantages described herein. Thus, in various embodiments, any of the features described herein from different embodiments may be combined.

References to “one embodiment”, “an embodiment”, “another embodiment”, “one example”, “a further embodiment”, “some embodiments”, “various embodiments”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. The appearance of the phrase “in one embodiment” in various places in the specification are not necessarily all referring to the same embodiment, nor are separate or alternative embodiments mutually exclusive of other embodiments. Some embodiments, illustrating its features, will now be discussed in detail. The words “having,” “containing,” and “including,” and other forms thereof, are intended to be equivalent in meaning and be open ended in that an item or items following any one of these words is not meant to be an exhaustive listing of such item or items, or meant to be limited to only the listed item or items. Further, the terms “a” and “an” herein do not denote a limitation of quantity, but rather denote the presence of at least one of the referenced items. Moreover, various features are described which may be exhibited by some embodiments and not by others. Similarly, various features are described which may be included in some embodiments but not in other embodiments. All illustrations of the drawings are for the purpose of describing selected versions of the present invention and are not intended to limit the scope of the present invention.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In various embodiments, a seatbelt enforcer may be configured to engage a seatbelt webbing and to selectively engage a steering wheel. The body of the seatbelt enforcer may be formed as a single integral piece, and the body may include a slot configured to receive the seatbelt webbing. The seatbelt enforcer may include a hook configured to engage a rim of the steering wheel. The hook may include a protrusion configured to increase contact area with the steering wheel rim and prevent unintended disengagement of the hook from the steering wheel. When the hook engages the steering wheel, the seatbelt enforcer may prevent retraction of the seatbelt webbing and may maintain a seatbelt clip in a predetermined position relative to the webbing.

The slot may be partially defined by a retaining arm configured to retain the seatbelt webbing within the slot. The retaining arm may be flexible and may deflect to allow insertion and removal of the seatbelt webbing. The retaining arm may include a rounded contact surface configured to engage the seatbelt webbing.

In various embodiments, the device may be configured to break away under a predetermined force threshold. This breakaway feature may allow emergency egress while the device is engaged with the steering wheel. The device may include structural reinforcement configured to provide rigidity during normal use while allowing the device to be made from a material that allows controlled breakage under emergency conditions.

When the seatbelt enforcer is engaged with the steering wheel, the seatbelt webbing may be maintained at an exact length necessary for an operator to fasten the seatbelt and the seatbelt clip may be maintained in a desired location. By holding the seatbelt webbing at an angle clipped to the steering wheel, gravity may be prevented from pulling the clip out of place. The operator may not need to make any adjustments to the webbing length or clip position, and the seatbelt may be quickly and easily fastened. When the seatbelt enforcer is engaged with the steering wheel, the seatbelt webbing may create a physical obstruction that prevents the steering wheel from being used, thereby preventing the vehicle from being driven until the operator has fastened the seatbelt. By unhooking the seatbelt enforcer and quickly latching the seatbelt that has the desired length of webbing and correctly positioned clip, the operator may simultaneously remove the obstruction, making the vehicle drivable. The seatbelt enforcer may be configured for high-frequency engagement and disengagement cycles.

A user can engage the seatbelt webbing with a slot of a seatbelt enforcer, and the user can fasten and unfasten the seatbelt without impediment. The user can unfasten the seatbelt, and can engage a hook of the seatbelt enforcer with a steering wheel rim. Hooking the seatbelt enforcer to the steering wheel can maintain the seatbelt webbing in an extended position at an exact length necessary for an operator to refasten the seatbelt when the operator returns to the vehicle. The seatbelt clip can be maintained in a desired location on the webbing while the hook engages the steering wheel. By holding the seatbelt webbing at an angle clipped to the steering wheel, gravity may be prevented from pulling the clip out of place. Hooking the seatbelt enforcer and webbing to the steering wheel can create a physical obstruction that prevents the steering wheel from being used, thereby preventing the vehicle from being driven until the operator has fastened the seatbelt. The user can disengage the hook from the steering wheel and fastening the seatbelt clip before operating the vehicle. By unhooking the seatbelt enforcer and quickly latching the seatbelt that has the desired length of webbing and correctly positioned clip, the operator may simultaneously remove the obstruction, making the vehicle drivable while also complying with seatbelt safety requirements.

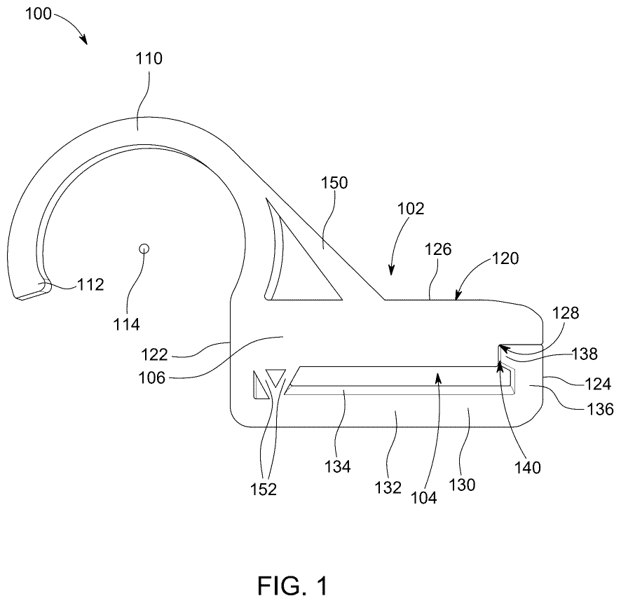

Referring now to FIG. 1, a perspective view of a seatbelt enforcer 100 is shown according to an illustrative embodiment. The seatbelt enforcer 100 may include a body 106, and the body may include a base 120. The base 120 may include a front sidewall 122, a rear sidewall 124, and a top of base 126. The body may include a finger cradle 102. The finger cradle 102 may be defined by the top of the base 126 and the side of the hood 110, and the finger cradle may provide a concavity configured to receive a user's finger or thumb. The finger cradle 102 may facilitate manipulation of the seatbelt enforcer 100 during installation and removal. Finger cradle 102 may be adapted to provide a convenient place for the user to wrap his finger(s) around the base of the seatbelt enforcer for easy placement.

The body may include a slot 104 that may be configured to receive seatbelt webbing. The body may include a hook 110 extending from the base 120. The seatbelt enforcer 100 may be substantially flat, with components arranged in a planar configuration. The base 120 may form the main body structure in the plane. The hook 110 may extend from the base 120, with the hook center point 114 positioned laterally beyond the sides of the base 120 and vertically above the top of base 126. The finger cradle 102 may be positioned above the top of base 126 and laterally to the side of the hook center point 114. This flat, planar arrangement may provide a compact device that can be easily manipulated with one hand.

The hook 110 may be configured to engage a steering wheel rim. The hook 110 may include a nub 112. The nub 112 may be a protrusion configured to increase contact area with the steering wheel rim. The nub 112 may inhibit unintended disengagement of the hook 110 from the steering wheel. The hook 110 may include a hook center point 114. The seatbelt enforcer 100 may include a retaining arm 130. The retaining arm 130 may cooperate with the base 120 to define the slot 104. The retaining arm 130 may include a straight section 132. The straight section 132 may extend parallel to the rest of the base 120 in a generally linear direction. The retaining arm 130 may include a rounded contact surface 134. The rounded contact surface 134 may be configured to engage seatbelt webbing and may distribute pressure to avoid damage to the webbing. The rounded contact surface may enable the seatbelt enforcer to more easily be slid up and down the webbing during use.

The retaining arm 130 may include a bend 136 forming a partial hook shape at the end of the retaining arm. The bend 136 may include an overhang 138 at the end of the bend. The overhang 138 may extend back away from the rear of the base, thereby creating a hook shaped interior of the retaining arm. The bend and the overhang may form a hook that can help to maintain the webbing in place and prevent the webbing from slipping out of the seatbelt enforcer. The base can define an overhang nook 128, and the overhang nook can be sized and shaped to partially encircle the overhang. The overhang can nest within the overhang nook, so that the engagement of the overhang within the overhang nook closes the retaining arm against the base.

The overhang 138 of the retaining arm 130 and the overhang nook 128 base 120 may together define a serpentine path 140 when the overhang is engaged within the nook. The serpentine path 140 can lock the webbing within the slot, preventing accidental release of the webbing. The webbing can only be released by deflecting the retaining arm to open a gap between the overhang and the overhang nook.

The seatbelt enforcer 100 may include structural reinforcement features. The structural reinforcement features may include a buttress 150. The buttress 150 may provide rigidity to the base 120 during normal use. The structural reinforcement features may include cross braces 152. The cross braces 152 may connect portions of the retaining arm to the body to increase structural integrity. The buttress 150 and cross braces 152 may be configured to provide rigidity during normal use while allowing controlled breakage under a predetermined force threshold for emergency egress. The breakable material can be broken in case of emergency if the driver needs to suddenly exit out from the left side of the vehicle or other emergencies. The structural reinforcement features allow the seatbelt enforcer to be constructed from a breakable material while remaining rigid enough for daily use.

The seatbelt enforcer 100 may be formed as a single integral piece. The single integral piece construction may simplify manufacturing and may eliminate assembly requirements. The single integral piece construction may be formed by injection molding, additive manufacturing, or other suitable fabrication processes.

The hook 110 may be positioned in a compact arrangement relative to the base 120. The seatbelt enforcer 100 may be substantially flat, with the base 120, hook 110, and finger cradle 102 arranged in a planar configuration. The hook center point 114 may be positioned laterally beyond the sides of the base 120, offset to the side of the base 120. The hook center point 114 may also be positioned above the top of base 126. The finger cradle 102 may be positioned above the top of base 126 and may be positioned laterally to the side of the hook center point 114. This planar arrangement may allow the hook 110 to remain out of the way when a user holds the base 120 using the finger cradle 102. The compact positioning may minimize the overall footprint of the seatbelt enforcer 100. When the hook 110 is engaged with a steering wheel rim, the compact arrangement may hold the base 120 close to the steering wheel. This proximity may reduce the distance the seatbelt enforcer 100 extends from the steering wheel and may minimize interference with vehicle operation or driver visibility. The forward offset of the hook center point 114 relative to the front sidewall 122 may also optimize the mechanical advantage when the hook 110 bears load from the seatbelt webbing tension. The forward offset also provides a finger cradle 102 defined by the top of the base and the side of the hook. This finger cradle allows the user to easily grasp and manipulate the seatbelt enforcer.

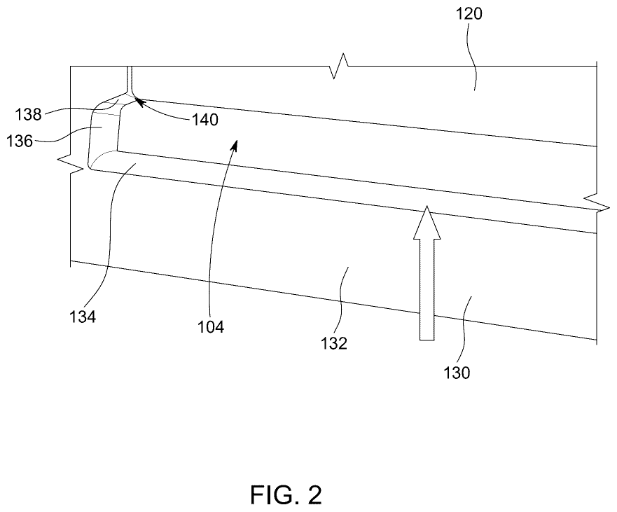

FIG. 2 is an enlarged view of the slot and rounded contact surface of the retaining arm, according to an illustrative embodiment. Referring now to FIG. 2, a detail view of the slot 104 and retaining arm 130 geometry is shown. The retaining arm 130 may include the straight section 132. The straight section 132 may extend from a connection point on the base 120 in a generally linear direction. The retaining arm 130 may include the bend 136 and the overhang 138. Together, the bend and the overhang form a hook at the end of the retaining arm. The hook at the end of the retaining arm can hold the webbing in place while the retaining arm is in the closed configuration, as shown in FIG. 2. The retaining arm 130 may include the rounded contact surface 134. The rounded contact surface 134 may be positioned at a belt-contact region where seatbelt webbing engages the retaining arm 130. The rounded contact surface 134 may distribute pressure across a larger contact area to avoid concentrating stress on the seatbelt webbing. The rounded contact surface 134 may reduce abrasion and wear on the seatbelt webbing during insertion, removal, and retention.

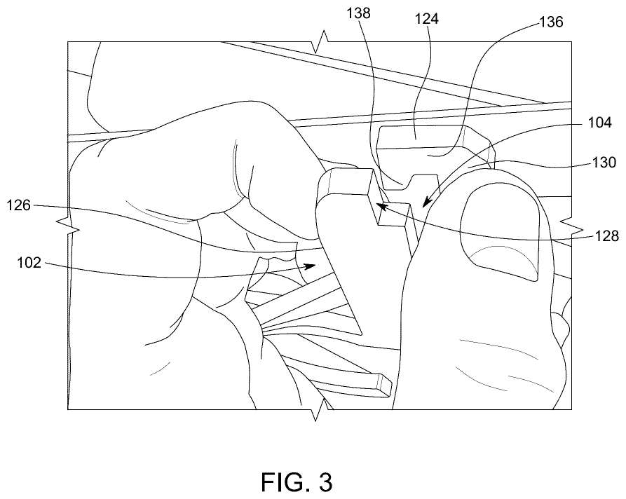

The overhang 138 may cooperate with the top of base 126 to define the overhang nook 128. The overhang nook 128 can partially encircle the overhang, and can engage with the overhang on more than one side of the overhang. The overhang nook 128 and the overhang 138 may define the serpentine path 140, which can provide a retention feature that prevents unintended disengagement of the seatbelt webbing from the slot 104. The webbing of the belt cannot pass through the serpentine path 140, thereby securing the webbing within the slot until the retaining arm is deflected into the open position, as shown in FIG. 3, below. The retaining arm 130 may be flexible. The flexibility of the retaining arm 130 may allow deflection to permit insertion and removal of the seatbelt webbing. When the seatbelt webbing is inserted into the slot 104, the retaining arm 130 may deflect outward to create a larger opening. When the seatbelt webbing is fully inserted, the retaining arm 130 may return toward its undeflected position, thereby capturing the seatbelt webbing within the serpentine path 140. The retaining arm 130 and the base 120 may together define the slot 104 for the webbing that provides both retention and ease of insertion and removal.

The serpentine path 140 may ensure that the seatbelt webbing 400 cannot slip out of the slot 104 accidentally. The seatbelt webbing 400 may only be removed from the slot 104 by deliberately flexing the retaining arm 130 outward and out of the plane of the base 120. When the retaining arm 130 is flexed out of the plane of the base 120, the serpentine path 140 may open into a larger opening. This opening may allow the seatbelt webbing 400 to pass between the overhang nook 128 and the overhang 138 when the retaining arm 130 and the base 120 are disengaged from each other. When the retaining arm 130 returns to its undeflected position in the plane of the base 120, the serpentine path 140 may close, preventing accidental removal of the seatbelt webbing 400.

FIG. 3 is a perspective view of the seatbelt enforcer with a user opening the retaining arm, according to an illustrative embodiment. Referring now to FIG. 3, a user is shown opening the retaining arm 130 of the seatbelt enforcer 100 in preparation for placing the belt 400 into the slot 104 is shown. The retaining arm 130 may be deflected outward from its undeflected position to create a larger opening for insertion of the seatbelt webbing 400. The deflection of the retaining arm 130 may be accomplished by applying force to the retaining arm 130 with a finger or thumb. The retaining arm 130 may be sufficiently flexible to allow deflection without permanent deformation. The retaining arm 130 may have a spring-like quality that biases the retaining arm 130 toward its undeflected position. The finger cradle 102 may be visible in this view and may provide a grip location for the user's opposite hand while the user deflects the retaining arm 130 with the other hand. The finger cradle 102 may stabilize the seatbelt enforcer 100 during the insertion operation. The overhang nook 128 may be visible as a constrained passage between the overhang 138 and the top of base 126. When the retaining arm 130 is deflected outward, the opening to the overhang nook 128 may be enlarged to facilitate threading of the seatbelt webbing 400. The spatial relationship between the finger cradle 102, the rear sidewall 124 of the base 120, the top of base 126, and the retaining arm 130 may be configured to allow single-handed operation. Alternatively, the user may use two hands during initial installations, with one hand stabilizing the base 120 via the finger cradle 102 and the other hand deflecting the retaining arm 130 and threading the seatbelt webbing 400. The seatbelt webbing 400 may be positioned near the slot 104 in preparation for insertion. The user may align the seatbelt webbing 400 with the opening created by the deflected retaining arm 130. Once the seatbelt webbing 400 is inserted into the slot 104 and threaded through the overhang nook 128, the user may release the retaining arm 130, allowing it to return toward its undeflected position and thereby capture the seatbelt webbing 400. The serpentine path 140 can effectively close the passage so that the webbing cannot be removed.

The deflection of the retaining arm 130 out of the plane of the base 120 may be the only way to remove the seatbelt webbing 400 from the slot 104. When the retaining arm 130 is in its undeflected position, the serpentine path 140 may close the passage such that the seatbelt webbing 400 cannot slip out accidentally. By flexing the retaining arm 130 outward and out of the plane of the base 120, the serpentine path 140 may open into a larger opening that allows the seatbelt webbing 400 to pass between the overhang nook 128 and the overhang 138 when they are disengaged from each other. This deliberate deflection requirement may prevent unintended disengagement while allowing intentional removal and insertion of the seatbelt webbing 400.

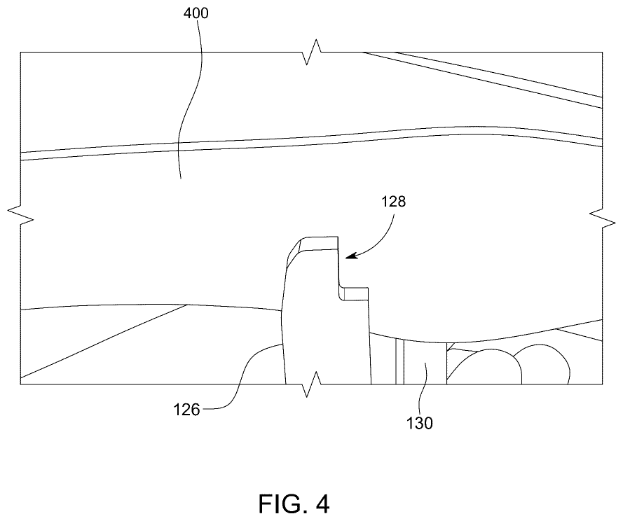

FIG. 4 is a perspective view of a seatbelt partially placed within the slot of the seatbelt enforcer, according to an illustrative embodiment. The seatbelt webbing 400 may be positioned within the slot 104 and may be engaged with the retaining arm 130. The overhang nook 128 paritally encircles the overhang 138, and the overhang nook and overhang may work together to constrain the seatbelt webbing 400 and may prevent the webbing from disengaging from the slot 104.

The rounded contact surface 134 of the retaining arm 130 may contact the seatbelt webbing 400. The rounded contact surface 134 may distribute pressure across the width of the seatbelt webbing 400 to avoid creating stress concentrations. The engagement between the rounded contact surface 134 and the seatbelt webbing 400 may reduce frictional resistance that inhibits sliding of the webbing out of the slot 104.

The top of base 126 may be visible in this view. The top of base 126 may define the overhang nook 128, and the overhang nook and the overhang may define the serpentine pathway. The serpentine path 140 may create a non-linear boundary that closes the passage and prevents the seatbelt webbing 400 from accidentally disengaging from the slot 104. The serpentine geometry may include sharp turns or angles that the seatbelt webbing cannot pass through. The retaining arm 130 has returned to the closed, undeflected position after the seatbelt webbing 400 was inserted. When the retaining arm 130 is in its undeflected position with the seatbelt webbing 400 captured in the slot 104, the retaining arm 130 may apply a retention force to the seatbelt webbing 400 that resists removal without deliberate deflection of the retaining arm 130.

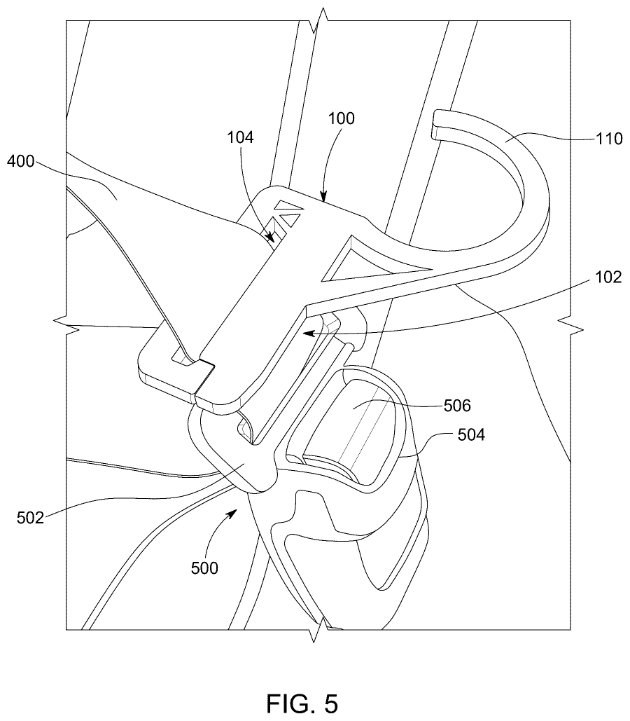

FIG. 5 is a perspective view of a seatbelt enforcer in place on a fastened seatbelt, according to an illustrative embodiment. The seatbelt enforcer 100 may be engaged with the seatbelt webbing 400 while the seatbelt is in a fastened state. The seatbelt webbing 400 may be captured within the slot 104 of the seatbelt enforcer 100. The seatbelt is shown latched with a latch assembly 500. The latch assembly 500 may include a clip 502, a receiver 504, and a release button 506. The clip 502 may be attached to the seatbelt webbing 400. The receiver 504 may be securely mounted to the floor of the vehicle. The clip 502 may be configured to engage the receiver 504 to fasten the seatbelt. When the clip 502 is engaged with the receiver 504, the seatbelt may be in a fastened state suitable for restraining an occupant during vehicle operation. The release button 506 may be configured to disengage the clip 502 from the receiver 504. When the release button 506 is actuated, the clip 502 may be released from the receiver 504, allowing the seatbelt to unfasten. The offset position of the hook provides a finger cradle 102 that allows the user to easily grasp the seatbelt enforcer and press the release button 506.

The seatbelt enforcer 100 may remain on the seatbelt webbing 400 during normal vehicle operation. The seatbelt enforcer 100 may not interfere with the fastening or unfastening operation of the latch assembly 500, and the offset position of the hook ensures that the seatbelt enforcer does not interfere. The seatbelt enforcer 100 may be configured to cooperate with standard automotive seatbelt systems without requiring modification to the vehicle seatbelt assembly. The seatbelt enforcer 100 may be a retrofit device that can be installed on existing seatbelt systems.

The hook 110 of the seatbelt enforcer 100 may be visible in this view. When the seatbelt is fastened and the vehicle is in operation, the hook 110 must not be engaged with the steering wheel. The seatbelt enforcer 100 may remain captured on the seatbelt webbing 400 in a passive state during driving, positioned such that it does not interfere with occupant comfort or seatbelt function.

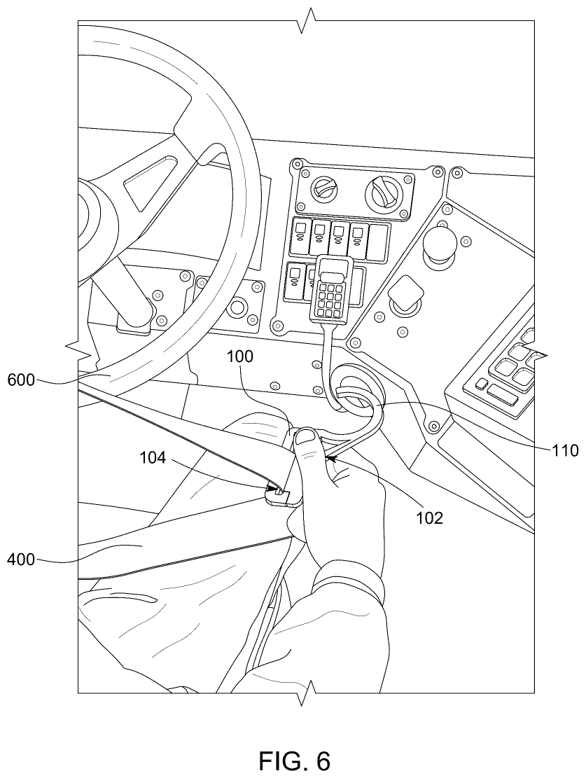

FIG. 6 is a perspective view of the user preparing to hook the seatbelt enforcer 100 to the steering wheel 600 after unfastening the belt 400, according to an illustrative embodiment. The hook 110 of the seatbelt enforcer 100 may be positioned to engage the rim of the steering wheel 600. The user may grasp the seatbelt enforcer 100 by the base 120 and may position the hook 110 over the rim of the steering wheel 600. The seatbelt webbing 400 may remain captured within the slot 104 of the seatbelt enforcer 100. The clip 502 may be visible and may be in an unfastened state, having been disengaged from the receiver 504. After the user unfastens the seatbelt by actuating the release button 506, the user may engage the hook 110 with the steering wheel 600 before exiting the vehicle.

The engagement of the hook 110 with the steering wheel 600 may prevent the seatbelt webbing 400 from retracting into the B-pillar retractor. This maintains the seatbelt webbing 400 at an exact length necessary for the user to fasten the seatbelt upon re-entry. The engagement may maintain the clip 502 in a desired location relative to the webbing by holding the seatbelt webbing 400 at an angle that prevents gravity from pulling the clip 502 out of place. The engagement may also create a physical obstruction that prevents the steering wheel 600 from being used until the user returns and fastens the seatbelt.

The nub 112 of the hook 110 may be positioned to contact the rim of the steering wheel 600. The nub 112 may increase the contact area between the hook 110 and the steering wheel rim. The increased contact area may increase friction and may inhibit unintended disengagement of the hook 110 from the steering wheel 600. The compact positioning of the hook 110 relative to the base 120 may allow the base 120 to be held close to the steering wheel 600 when the hook 110 is engaged. This proximity may minimize the distance the seatbelt enforcer 100 extends from the steering wheel 600. The forward offset of the hook center point 114 relative to the front sidewall 122 of the base 120 may reduce mechanical stress when the hook 110 bears load from tension in the seatbelt webbing 400.

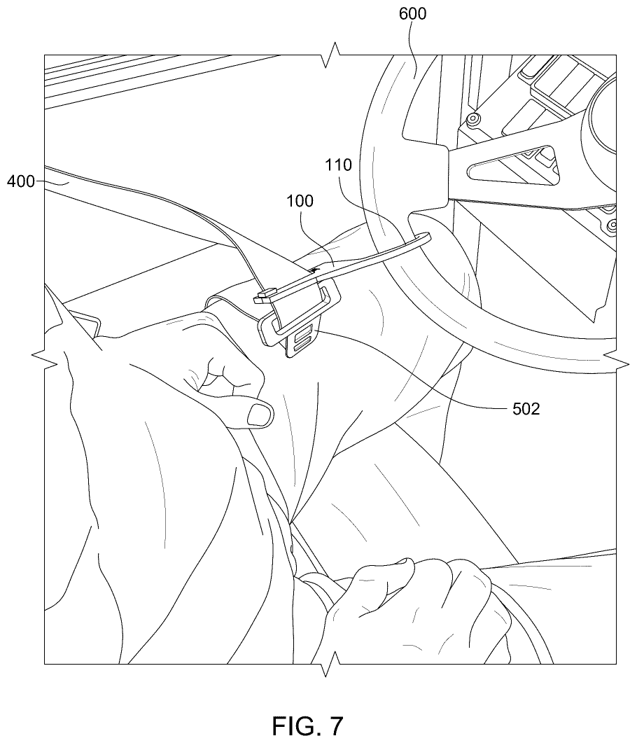

FIG. 7 is a perspective view of the seatbelt enforcer hooked to the steering wheel, thereby preventing the seatbelt from retracting and preventing the vehicle from being driven, according to an illustrative embodiment. The hook 110 may be engaged with the rim of the steering wheel 600. The seatbelt enforcer 100 may maintain the seatbelt webbing 400 in an extended position. The extended position may prevent the seatbelt webbing 400 from retracting into the B-pillar retractor. The extended position may maintain the seatbelt webbing 400 at an exact length necessary for an operator to fasten the seatbelt. The clip 502 may be maintained in a desired location relative to the steering wheel 600. By holding the seatbelt webbing 400 at an angle clipped to the steering wheel 600, gravity may be prevented from pulling the clip 502 out of place. The desired location may allow the operator to easily locate and grasp the clip 502 upon re-entry to the vehicle without needing to make any adjustments to the webbing length or clip position. The seatbelt may be quickly and easily fastened. The seatbelt webbing 400 may create a physical obstruction that prevents the steering wheel 600 from being used. The physical obstruction may prevent the vehicle from being driven while the seatbelt enforcer 100 is engaged with the steering wheel 600. The obstruction may require the operator to disengage the hook 110 from the steering wheel 600 and fasten the seatbelt before operating the vehicle. By unhooking the seatbelt enforcer 100 and quickly latching the seatbelt that already has the desired length of webbing and correctly positioned clip 502, the operator may simultaneously remove the obstruction, making the vehicle drivable. The nub 112 of the hook 110 may be in contact with the rim of the steering wheel 600. The nub 112 may provide increased friction that resists unintended disengagement during vehicle exit and entry cycles.

The base 120 may be held close to the steering wheel 600 due to the compact positioning of the hook 110. The seatbelt enforcer 100 may remain engaged with the steering wheel 600 while the operator exits the vehicle through the passenger-side door or through a center position toward the rear of the vehicle. The compact design of the base and the hook may keep the seatbelt enforcer, the webbing, and the clip in an out of the way position as the driver exits and enters the seat. When the operator returns to the vehicle, the seatbelt webbing 400 and clip 502 may remain in the predetermined position, eliminating the need to retrieve a retracted belt or reposition a migrated clip.

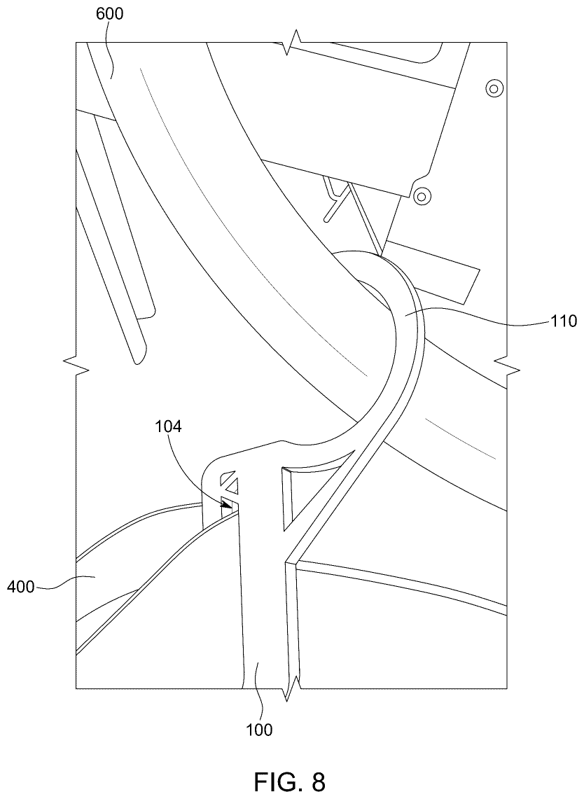

FIG. 8 is an enlarged view of the seatbelt enforcer 100 hooked to the steering wheel 600, according to an illustrative embodiment. The hook 110 may be engaged with the rim of the steering wheel 600. The nub 112 may be in contact with the rim of the steering wheel 600. The nub 112 can be a protrusion that increases the contact area between the hook 110 and the steering wheel rim. The increased contact area may distribute load across a larger surface and may increase frictional resistance to sliding or disengagement. The hook center point 114 may be offset forward of the front sidewall 122 of the base 120. This forward offset may position the hook 110 to bear load efficiently when tension is applied to the seatbelt webbing 400. The base 120 may be positioned close to the steering wheel 600. The compact arrangement of the hook 110 relative to the base 120 may minimize the distance between the base 120 and the steering wheel 600 when the hook 110 is engaged. This keeps the seatbelt enforcer, the seatbelt webbing, and the clip in an out of the way location while the driver is exiting and reentering the vehicle. The forward offset of the hook further allows the user to easily grasp the base with a finger or thumb in the finger cradle defined by the top of the base, the hook, and/or the buttress.

The seatbelt webbing 400 may be captured within the slot 104. The slot 104 may retain the seatbelt webbing 400 and may resist unintended disengagement of the webbing out of the slot 104. The serpentine path 140 defined by the retaining arm 130 and the base 120 may close the between the overhang and the overhang nook, and may prevent the seatbelt webbing 400 from accidentally disengaging from the slot 104.

The rounded contact surface 134 of the retaining arm 130 may contact the seatbelt webbing 400. The angle at which the seatbelt webbing 400 is held when the hook 110 is engaged with the steering wheel 600 may prevent gravity from pulling the clip 502 down the seatbelt webbing 400. When the seatbelt webbing 400 is clipped to the steering wheel 600 at an angle, the clip 502 may be supported by the tension in the webbing. This angled positioning may prevent the clip 502 from migrating down the webbing toward the B-pillar. The angled positioning may maintain the clip 502 in a desired location that allows an operator to quickly grasp and fasten the clip 502 upon re-entry without needing to reposition the clip along the webbing. The engagement of the hook 110 with the steering wheel 600 may prevent the seatbelt webbing 400 from retracting into the B-pillar retractor. The engagement may maintain the seatbelt webbing 400 at an exact length necessary for the operator to fasten the seatbelt. The combination of maintaining the exact webbing length and maintaining the clip 502 in the desired location may allow the operator to quickly and easily fasten the seatbelt without making any adjustments. Furthermore, the seatbelt webbing 400 may create a physical obstruction that prevents the steering wheel 600 from being used. The physical obstruction may prevent the vehicle from being driven while the seatbelt enforcer 100 is engaged with the steering wheel 600. By unhooking the seatbelt enforcer 100 and quickly latching the seatbelt that has the desired length of webbing and correctly positioned clip 502, the operator may simultaneously remove the obstruction, making the vehicle drivable while also complying with seatbelt safety requirements before driving.

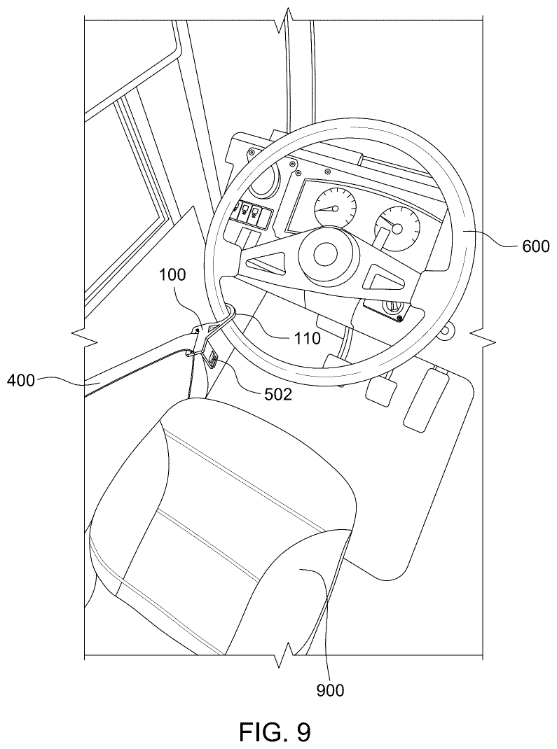

FIG. 9 is a perspective view of the seatbelt enforcer 100 hooked to the steering wheel 600 with the belt 400 held in place while the driver exits to the right, according to an illustrative embodiment. The hook 110 may be engaged with the rim of the steering wheel 600. The seatbelt enforcer 100 may maintain the seatbelt webbing 400 in an extended position while the driver is absent from the vehicle. The driver may have exited the vehicle through the passenger-side door or through a center position toward the rear of the vehicle. The seatbelt webbing 400 may remain captured within the slot 104 of the seatbelt enforcer 100. The seatbelt enforcer 100 may prevent the seatbelt webbing 400 from retracting into the B-pillar retractor during the driver's absence. The seatbelt webbing 400 may be maintained at an exact length necessary for the driver to fasten the seatbelt upon return. The clip 502 may be maintained in a desired position along the seatbelt webbing 400 during the driver's absence. The angle at which the seatbelt webbing 400 is held when the hook 110 is engaged with the steering wheel 600 may prevent gravity from pulling the clip 502 down the seatbelt webbing 400. The clip 502 may remain in the desired position along the webbing throughout the driver's absence, whether the driver is absent for seconds or minutes. When the driver returns to the vehicle, the seatbelt webbing 400 and clip 502 may be immediately available in the correct position and at the correct length for fastening. The driver may not need to retrieve a retracted belt or reposition a migrated clip. The seatbelt enforcer 100 may maintain the belt and clip in place during high-frequency commercial vehicle operations where the driver may exit and re-enter dozens or hundreds of times per day.

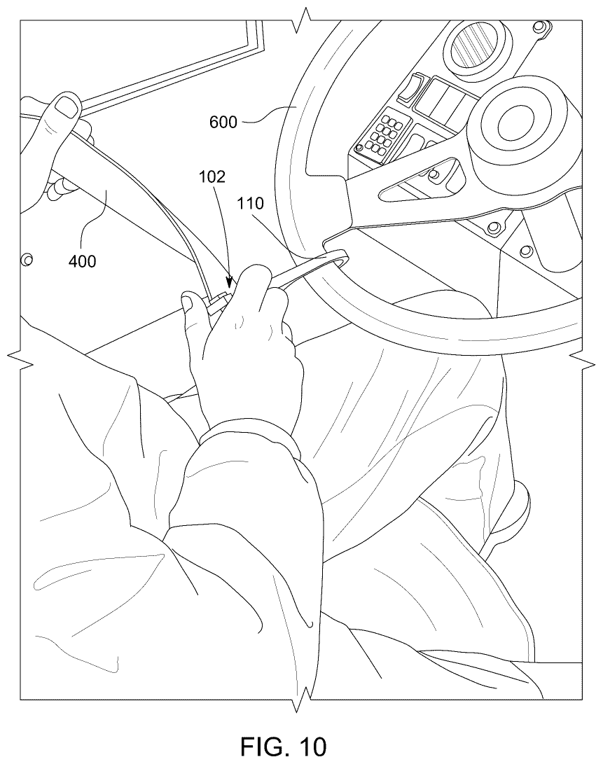

FIG. 10 is a perspective view of the driver returning to the vehicle and preparing to unhook the seatbelt enforcer 100 from the steering wheel 600, according to an illustrative embodiment. The driver may be re-entering the vehicle after having exited through the passenger-side door or through a center position toward the rear of the vehicle. The hook 110 may be engaged with the rim of the steering wheel 600. The compact positioning of the hook 110 relative to the base 120 may allow the seatbelt enforcer 100, the seatbelt webbing 400, and the clip 502 to remain out of the way as the driver re-enters the vehicle. The seatbelt enforcer 100 may have maintained the seatbelt webbing 400 in an extended position during the driver's absence. The clip 502 may have been maintained in a desired position along the seatbelt webbing 400 during the driver's absence. The driver may grasp the base 120, with a finger positioned in the finger cradle 102, to prepare to disengage the hook 110 from the steering wheel 600. The finger cradle 102 may make it easier and more comfortable for the driver to hold the base 120 during the unhooking operation. The hook 110 may be offset out of the way, allowing the driver to comfortably grip the base 120 without interference from the hook 110. The driver may apply force to lift or rotate the hook 110 away from the steering wheel rim to disengage the hook 110. The nub 112 may disengage from contact with the steering wheel rim as the hook 110 is lifted.

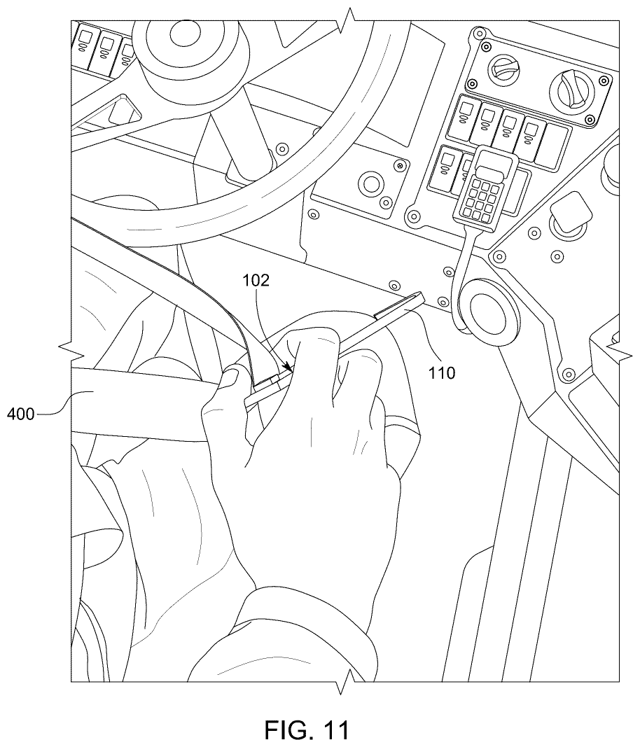

FIG. 11 is a perspective view of the driver preparing to fasten the belt 400, according to an illustrative embodiment. The driver may have disengaged the hook 110 from the steering wheel 600. The seatbelt enforcer 100 may remain on the seatbelt webbing 400 after the hook 110 is disengaged from the steering wheel 600, and the seatbelt webbing 400 may remain captured within the slot 104 of the seatbelt enforcer 100. The seatbelt webbing 400 may remain at an exact length necessary for the driver to fasten the seatbelt. The clip 502 may remain in a desired position along the seatbelt webbing 400. The driver may immediately grasp the clip 502 without needing to retrieve a retracted belt or reposition a migrated clip along the webbing, and the driver may not need to make any adjustments to the webbing length or clip position. The driver may position the clip 502 to be engaged in the receiver 504. By unhooking the seatbelt enforcer 100 and quickly latching the seatbelt that has the desired length of webbing and correctly positioned clip 502, the driver may simultaneously remove the physical obstruction from the steering wheel 600, making the vehicle drivable.

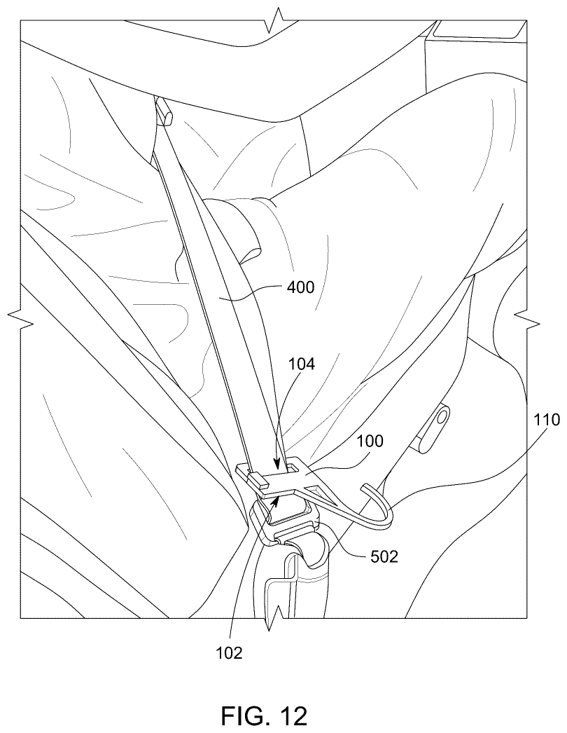

FIG. 12 is a perspective view of the belt 400 fastened with the seatbelt enforcer 100 resting above the clip 502, according to an illustrative embodiment. The seatbelt is shown in a fastened state, and the clip 502 may be engaged with the receiver 504. The seatbelt enforcer 100 may remain captured on the seatbelt webbing 400 during normal vehicle operation while the seatbelt is fastened, and the seatbelt enforcer 100 may be positioned on the seatbelt webbing 400 above the clip 502. The seatbelt enforcer 100 may be positioned such that it does not interfere with the fastening operation or with occupant comfort during driving. The compact positioning of the hook 110 relative to the base 120 may allow the seatbelt enforcer 100 to remain out of the way during the fastening operation and during normal vehicle operation. The seatbelt enforcer 100 may remain available on the seatbelt webbing 400 for the next exit cycle. When the driver prepares to exit the vehicle again, the driver may unfasten the seatbelt by actuating the release button 506 and may then engage the hook 110 with the steering wheel 600 to repeat the cycle. The seatbelt enforcer 100 may be configured for repeated high-frequency engagement and disengagement cycles throughout the workday in commercial vehicle operations.

In some embodiments, a method of use may include the following operational cycle. An operator may enter a vehicle and may fasten a seatbelt by engaging a clip 502 with a receiver 504. The seatbelt enforcer 100 may remain on the seatbelt webbing 400 in a passive state during this fastening operation. The operator may drive the vehicle with the seatbelt fastened. The operator may stop the vehicle at a destination. The operator may unfasten the seatbelt by actuating a release button 506 to disengage the clip 502 from the receiver 504. The operator may grasp the base 120 of the seatbelt enforcer 100, with a finger positioned in the finger cradle 102, and may engage the hook 110 with a rim of a steering wheel 600. When the hook 110 is engaged with the steering wheel 600, the seatbelt enforcer 100 may prevent the seatbelt webbing 400 from retracting into a B-pillar retractor and may maintain the clip 502 in a desired position along the seatbelt webbing 400 by holding the webbing at an angle that prevents gravity from pulling the clip 502 down the webbing. The seatbelt webbing 400 may create a physical obstruction that prevents the steering wheel 600 from being used. The operator may exit the vehicle through a passenger-side door or through a center position toward the rear of the vehicle. The seatbelt enforcer 100 may maintain the seatbelt webbing 400 at an exact length necessary for fastening and may maintain the clip 502 in the desired position along the webbing during the operator's absence. The operator may re-enter the vehicle. The operator may grasp the base 120, with a finger positioned in the finger cradle 102, and may disengage the hook 110 from the steering wheel 600 by lifting or rotating the hook 110 away from the steering wheel rim. The seatbelt webbing 400 may remain at the exact length necessary for fastening and the clip 502 may remain in the desired position along the webbing. The operator may immediately grasp the clip 502 without needing to retrieve a retracted belt or reposition a migrated clip along the webbing. The operator may fasten the seatbelt by engaging the clip 502 with the receiver 504. By unhooking the seatbelt enforcer 100 and quickly latching the seatbelt, the operator may simultaneously remove the physical obstruction from the steering wheel 600, making the vehicle drivable. The operator may drive the vehicle with the seatbelt fastened. This operational cycle may be repeated dozens or hundreds of times per day in commercial vehicle operations.

Although this invention has been disclosed in the context of certain preferred embodiments and examples, it should be understood by those skilled in the art that the present invention extends beyond the specifically disclosed embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Also, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 5%) of the system. Accordingly, this description is meant to be taken only by way of example, and not to otherwise limit the scope of this invention.

What is claimed is:

1. A seatbelt enforcer for use with a vehicle seatbelt system, the seatbelt enforcer comprising:
a body comprising a slot configured to receive a seatbelt webbing; and
a hook extending from the body and configured to engage a steering wheel rim;
wherein, when the hook engages the steering wheel rim and the seatbelt webbing is received in the slot, the seatbelt enforcer is configured to prevent retraction of the seatbelt webbing and to maintain a seatbelt clip in a desired position along the seatbelt webbing while the seatbelt is unfastened.

2. The seatbelt enforcer of claim 1, wherein the hook is positioned forward of a front sidewall of a base of the body such that the hook remains out of the way when a user holds the base.

3. The seatbelt enforcer of claim 1, wherein the slot comprises a retaining arm configured to retain the seatbelt webbing within the slot.

4. The seatbelt enforcer of claim 3, wherein the retaining arm is flexible and configured to deflect to allow insertion and removal of the seatbelt webbing.

5. The seatbelt enforcer of claim 3, wherein the retaining arm and the body define a serpentine path that closes a passage and prevents the seatbelt webbing from accidentally disengaging from the slot.

6. The seatbelt enforcer of claim 1, wherein the hook comprises a nub configured to increase contact area with the steering wheel rim.

7. The seatbelt enforcer of claim 1, wherein the seatbelt enforcer is configured to break away under a predetermined force threshold.

8. The seatbelt enforcer of claim 3, wherein the retaining arm comprises an overhang and the body comprises a top of base, the overhang and the top of base defining an overhang nook configured to constrain the seatbelt webbing.

9. The seatbelt enforcer of claim 1, wherein, when the hook engages the steering wheel rim, the seatbelt webbing is held at an angle that prevents gravity from pulling the seatbelt clip down the seatbelt webbing.

10. The seatbelt enforcer of claim 1, wherein, when the hook engages the steering wheel rim, the seatbelt enforcer and seatbelt webbing create a physical obstruction that prevents the steering wheel from being used.

11. A vehicle occupant restraint system comprising:
a vehicle seatbelt assembly comprising
a seatbelt webbing,
a seatbelt clip, and
a retractor; and
a seatbelt enforcer comprising:
a body comprising a slot configured to receive the seatbelt webbing, and
a hook extending from the body and configured to engage a steering wheel rim;
wherein, when the hook engages the steering wheel rim and the seatbelt webbing is received in the slot, the seatbelt enforcer is configured to prevent the retractor from retracting the seatbelt webbing and to maintain the seatbelt clip in a desired position along the seatbelt webbing.

12. The system of claim 11, wherein, when the hook engages the steering wheel rim, the seatbelt webbing is held at an angle that prevents gravity from pulling the seatbelt clip down the seatbelt webbing.

13. The system of claim 11, wherein, when the hook engages the steering wheel rim, the seatbelt webbing creates a physical obstruction that prevents the steering wheel from being used, thereby preventing the vehicle from being driven until an operator has fastened the seatbelt.

14. A method for retaining a seatbelt in a vehicle, the method comprising:
engaging a seatbelt webbing with a slot of a seatbelt enforcer;
engaging a hook of the seatbelt enforcer with a steering wheel rim;
maintaining the seatbelt webbing in an extended position at a desired length for an operator to fasten the seatbelt while the hook engages the steering wheel rim; and
maintaining a seatbelt clip in a desired position along the seatbelt webbing while the hook engages the steering wheel rim by holding the seatbelt webbing at an angle that prevents gravity from pulling the seatbelt clip down the seatbelt webbing.

15. The method of claim 14, further comprising creating a physical obstruction with the seatbelt webbing that prevents the steering wheel from being used, thereby preventing the vehicle from being driven until the operator has fastened the seatbelt.

16. The method of claim 14, further comprising disengaging the hook from the steering wheel rim and fastening the seatbelt clip before operating the vehicle.

17. The method of claim 15, wherein disengaging the hook and fastening the seatbelt clip simultaneously removes the physical obstruction from the steering wheel, making the vehicle drivable.

18. The method of claim 14, wherein the operator exits the vehicle through a passenger-side door or through a center position toward a rear of the vehicle while the hook engages the steering wheel rim.

19. The method of claim 17, wherein the seatbelt webbing maintained at the desired length and the seatbelt clip maintained in the desired position along the seatbelt webbing allow the operator to fasten the seatbelt without making any adjustments to webbing length or clip position.
